(19) United States
(12) Patent Application Publication
(10) Pub. No.: US 2026/0112784 A1
(43) Pub. Date: Apr. 23, 2026

(54) BUSBAR MODULE

(71) Applicants: Yazaki Corporation, Tokyo (JP); TOYOTA JIDOSHA KABUSHIKI KAISHA, Toyota-shi (JP)

(72) Inventors: Yuki OHIRA, Nisshin-shi (JP); Makoto Abe, Toyota-shi (JP); Ryo Sakagami, Shizuoka (JP); Shigeyuki Ogasawara, Shizuoka (JP); Hideki Inoue, Shizuoka (JP)

(73) Assignees: Yazaki Corporation, Tokyo (JP); TOYOTA JIDOSHA KABUSHIKI KAISHA, Toyota-shi (JP)

(21) Appl. No.: 19/350,331

(22) Filed: Oct. 6, 2025

(30) Foreign Application Priority Data
Oct. 18, 2024 (JP) 2024-182419

(51) Int. Cl. H01M 50/514; H01M 50/209; H01M 50/298; H01M 50/503

(52) U.S. Cl. CPC H01M 50/514; H01M 50/209; H01M 50/298; H01M 50/503

(57) ABSTRACT

To provide a busbar module that can appropriately perform water processing inside. A busbar module includes a busbar connected to a battery cell; a terminal connected to the busbar; and a case including a busbar housing part that houses the busbar and the terminal, and a connection housing part that is disposed to communicate with a lower side of the busbar housing part and houses a connection part between the terminal and the electric wire. The connection housing part is formed to be open downward in a vertical direction in a state of being assembled to the battery cell.

### CROSS-REFERENCE TO RELATED APPLICATION(S)

The present application claims priority to and incorporates by reference the entire contents of Japanese Patent Application No. 2024-182419 filed in Japan on Oct. 18, 2024.

### BACKGROUND OF THE INVENTION

### 1. Field of the Invention The present invention relates to a busbar module.

### 2. Description of the Related Art

In the related art, for example, Japanese Patent Application Laid-open No. 2014-093218 discloses a busbar module.

As disclosed in Japanese Patent Application Laid-open No. 2014-093218, there is known a busbar module that is attached to a side surface of a battery assembly and constitutes a power supply device. This busbar module has a case, the case including a plurality of busbar housing parts, a terminal for voltage detection disposed to be adjacent to each of the busbar housing parts, a routing part that routes a voltage detection line connected to the terminal for voltage detection, and a cover that covers a predetermined range of the routing part.

In such a busbar module, when water condensation occurs on a busbar and waterdrops are generated, it is required to properly perform processing such as discharge of water from a busbar cavity such as the busbar housing part. The busbar module has room for improvement regarding processing of water accumulated in the busbar cavity.

### SUMMARY OF THE INVENTION

Thus, the present invention aims at providing a busbar module that can appropriately perform water processing.

A busbar module according to one aspect of the present invention includes a busbar connected to a battery cell; a terminal connected to the busbar; and a case including a busbar housing part that houses the busbar and the terminal, and a connection housing part that is disposed to communicate with a lower side of the busbar housing part and houses a connection part between the terminal and the electric wire, wherein the connection housing part is formed to be open downward in a vertical direction in a state of being assembled to the battery cell.

### BRIEF DESCRIPTION OF THE DRAWINGS

FIG. 1 is a perspective view of a busbar module according to an embodiment.

FIG. 2 is an enlarged perspective view of the busbar module according to the embodiment.

FIG. 3 is an enlarged perspective view of the busbar module according to the embodiment.

FIG. 4 is an explanatory diagram of water processing in the busbar module according to the embodiment.

FIG. 5 is an explanatory diagram of a busbar module of a comparative example.

### DETAILED DESCRIPTION OF THE PREFERRED EMBODIMENTS

The following describes an embodiment according to the present invention in detail based on the drawings. The present invention is not limited to the embodiment. Constituent elements in the following embodiment include constituent elements that can be easily replaced by those skilled in the art, or constituent elements that are substantially the same.

### Embodiment

The present embodiment relates to a busbar module. In the following description, among a first direction, a second direction, and a third direction intersecting with each other, the first direction is referred to as a “depth direction X”, the second direction is referred to as a “width direction Y”, and the third direction is referred to as a “vertical direction Z”. Herein, the depth direction X, the width direction Y, and the vertical direction Z are orthogonal to each other.

Herein, “orthogonal” includes “substantially orthogonal”. Unless otherwise specified, each direction used in the following description represents a direction in a state where parts are assembled with each other.

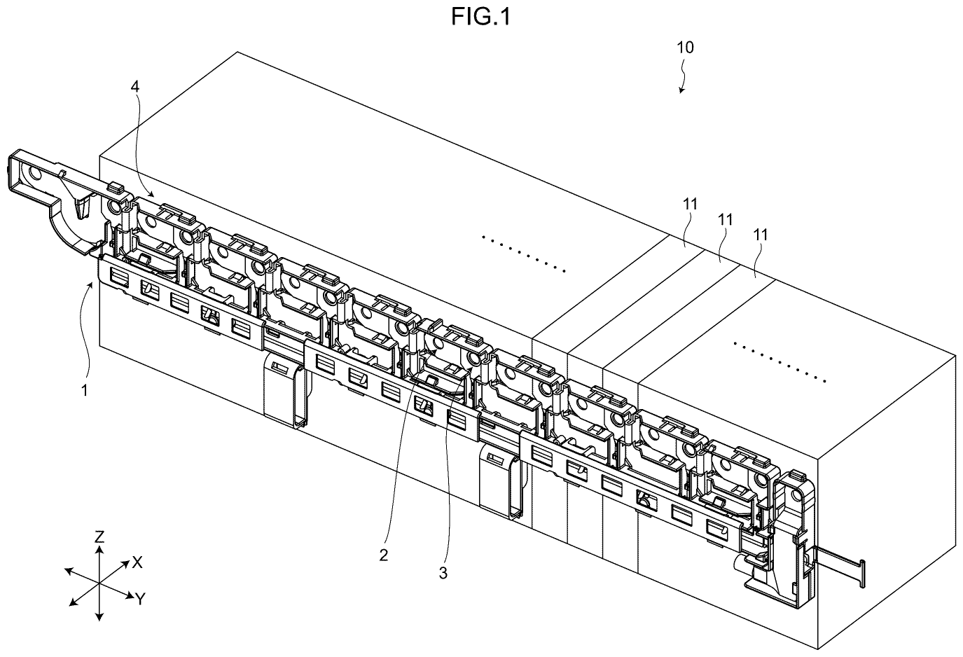

As illustrated in FIG. 1, a busbar module 1 in the present embodiment is used while being assembled to a battery cell 11, and the battery cell 11 and the busbar module 1 constitute a battery module 10, for example. A plurality of the battery cells 11 are disposed, and arranged side by side in the width direction Y, for example. That is, the battery cells 11 are stacked and arranged side by side in the width direction Y. For example, a plurality of the battery modules 10 are disposed to constitute a battery pack, and used as a power source for a vehicle such as an electric vehicle or a hybrid electric vehicle.

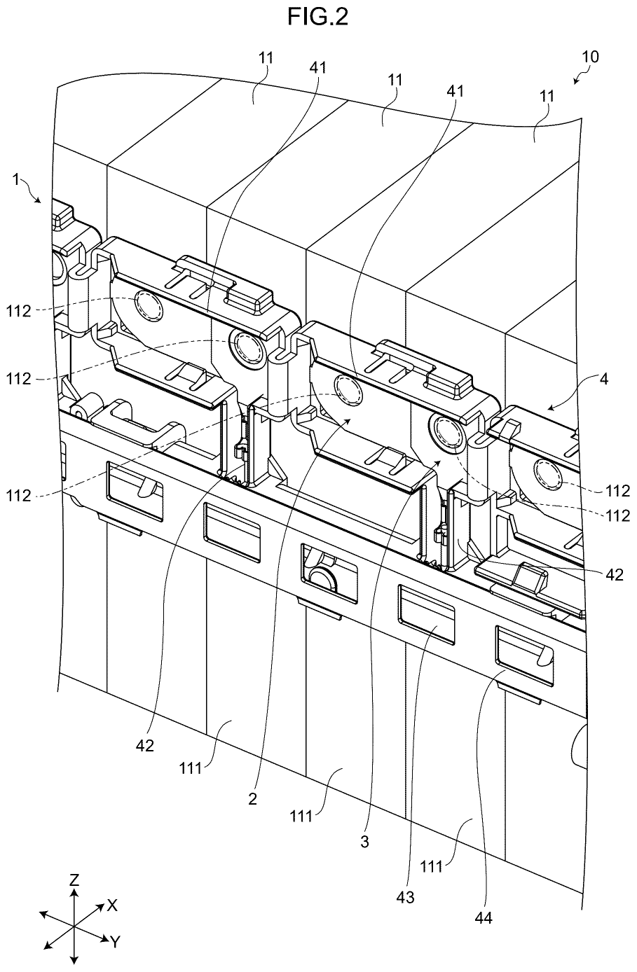

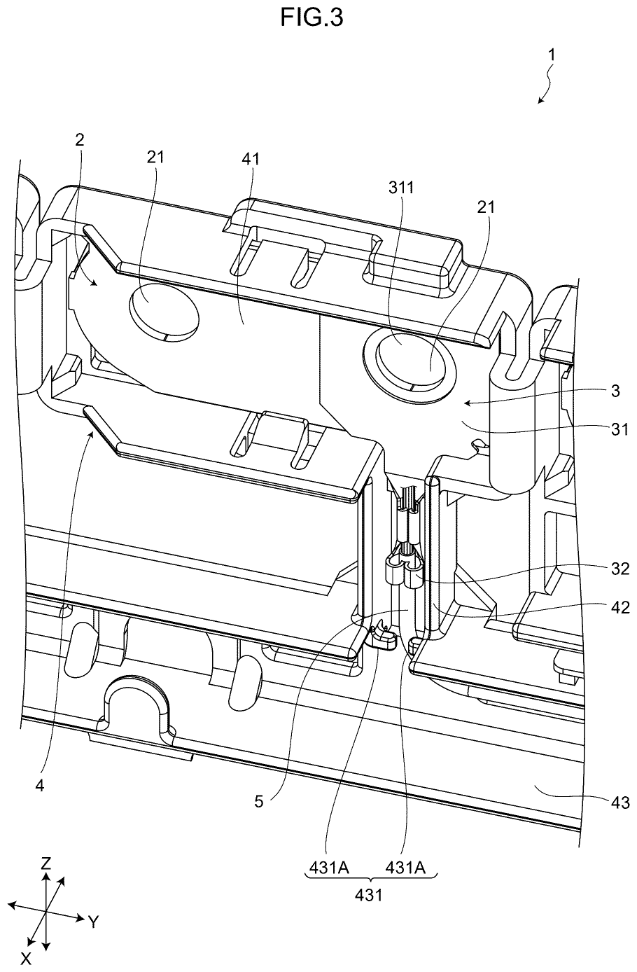

As illustrated in FIG. 2 and FIG. 3, the battery cell 11 constitutes what is called an electric cell, and a plurality of the battery cells 11 are arranged along the width direction Y to constitute a battery pack. An electrode 112 is disposed on an electrode arrangement surface 111 of the battery cell 11. The electrode arrangement surface 111 is, for example, a surface including the width direction Y and a height direction Z in the battery cell 11, and two surfaces on a front side and a back side correspond thereto. FIG. 2 illustrates only parts of the busbar module 1 and the battery module 10, and some of the battery cells 11, that is, illustrates only the electrode arrangement surface 111 on the front side and does not illustrate the electrode arrangement surface 111 on the back side.

The busbar module 1 includes a busbar 2, a terminal 3, and a case 4. The busbar 2 is an electric conductor formed of a conductive metal plate, and connects the electrode 112 with the electrode 112 of the battery cells 11 adjacent to each other in the width direction Y. A plurality of the busbars 2 are disposed in accordance with the number of the battery cells 11 installed, for example. The busbar 2 is formed in a rectangular plate shape, and has two connection holes 21 formed therethrough from the front side to the back side. Herein, “rectangular” includes “substantially rectangular”. One electrode 112 and the other electrode 112 of the adjacent battery cells 11 are inserted through the two connection holes 21. A hole shape of the connection hole 21 is set in accordance with a shape of the electrode 112, and is a circular shape, for example. One of the two electrodes 112 of the adjacent battery cells 11 is a positive electrode, and the other one thereof is a negative electrode. A shape of the busbar 2, a forming position of the connection hole 21, and the like may be in forms other than those illustrated in FIG. 1 to FIG. 3.

The terminal 3 is connected to the busbar 2. The terminal 3 is a terminal for detecting a voltage of the battery cell 11, and is an electric conductor formed of conductive metal. The terminal 3 detects voltages of the busbar 2 and the electrode 112, and is connected to a monitoring device (not illustrated) via an electric wire 5. Due to this, the voltage of the battery cell 11 can be detected and monitored.

The terminal 3 includes a conductor connection part 31 and an electric wire connection part 32. The conductor connection part 31 is a portion connected to the busbar 2, and formed in a rectangular plate shape, for example. The conductor connection part 31 is disposed to overlap the busbar 2 in the depth direction X, and is arranged at a position where one of the two connection holes 21 is formed, for example. A through hole 311 passing through the front side and the back side is formed in the conductor connection part 31. The through hole 311 is a hole through which the electrode 112 is inserted, and formed as a circular hole, for example. The terminal 3 is arranged so that the through hole 311 matches a position of the connection hole 21 of the busbar 2.

The electric wire connection part 32 is a portion connected to the electric wire 5, and has an open-barrel shape, for example. The electric wire 5 is crimped and connected thereto. The electric wire 5 is, for example, a covered electric wire, and is configured by covering an outer periphery of a conductive core wire with an insulating covering part. The electric wire connection part 32 is formed downward from the conductor connection part 31.

The case 4 is a housing body that is assembled to the battery cell 11 to house and hold the busbar 2 and the terminal 3, and is formed of an insulating material such as resin, for example. The case 4 includes a busbar housing part 41 and a connection housing part 42. The busbar housing part 41 is a portion that houses the busbar 2 and the terminal 3, has a box shape having a rectangular cross-sectional shape in a direction intersecting with the depth direction X, and is formed in a size capable of housing the busbar 2. For example, the busbar housing part 41 houses the busbar 2 and the conductor connection part 31 of the terminal 3. A plurality of the busbar housing parts 41 are disposed in accordance with the number of the busbars 2 installed, and are disposed to be coupled to each other in the width direction Y in a state of being assembled to the battery cell 11.

The connection housing part 42 is a portion that houses a connection part between the terminal 3 and the electric wire 5, and is disposed to communicate with a lower side of the busbar housing part 41. The connection housing part 42 has a box shape having a rectangular cross-sectional shape in the direction intersecting with the depth direction X, and houses the electric wire connection part 32 of the terminal 3 and an end part of the electric wire 5, for example. A plurality of the connection housing parts 42 are disposed in accordance with the number of the busbar housing parts 41 installed, and are disposed at positions below the respective busbar housing parts 41. The connection housing part 42 is formed to be open downward in the vertical direction Z in a state where the case 4 is assembled to the battery cell 11. That is, the connection housing part 42 does not have a floor part, and communicates with an electric wire housing part 43 in the same shape as a cross section in a direction intersecting with the vertical direction Z. The electric wire housing part 43 is a housing part formed below the connection housing part 42 along the width direction Y, and serves as a space for routing the electric wire 5 connected to each terminal 3 in the width direction Y. A cover 44 is attached to the electric wire housing part 43 to prevent the electric wire 5 from coming out from the electric wire housing part 43. The busbar module 1 can prevent water from accumulating in the connection housing part 42 by forming the connection housing part 42 to be open downward in the vertical direction Z in a state of being assembled to the battery cell 11.

In the connection housing part 42, an opening is formed in a back part opposed to the electrode arrangement surface 111 of the battery cell 11 in a state where the case 4 is assembled to the battery cell 11. When the opening is formed in the back part of the connection housing part 42, water can flow to a lower side of the connection housing part 42 through the opening in the back part of the connection housing part 42, so that the busbar module 1 can prevent water from accumulating in the connection housing part 42.

An electric wire lock part 431 is disposed on the electric wire housing part 43. The electric wire lock part 431 is a portion that supports the electric wire 5 from a lateral side. The electric wire lock part 431 includes, for example, a pair of holding pieces 431A and 431A that hold the electric wire from the lateral side of the electric wire 5. The electric wire lock part 431 is disposed on the electric wire housing part 43 instead of the connection housing part 42, so that water such as waterdrops can be prevented from moving to a connection portion between the terminal 3 and the electric wire 5 through the electric wire lock part 431.

The connection part between the terminal 3 and the electric wire 5 is arranged at a center position or a position above the center of the connection housing part 42. For example, in the connection housing part 42, the connection portion between the terminal 3 and the electric wire 5 is arranged at the center position or a position above the center in the vertical direction Z. Herein, the “center position” includes a “substantially center position”. By arranging the connection part between the terminal 3 and the electric wire 5 at the center position or a position above the center of the connection housing part 42, the connection part between the terminal 3 and the electric wire 5 is prevented from being exposed to water such as waterdrops.

Next, the following describes water processing of the busbar module 1 according to the present embodiment.

In FIG. 1, when water condensation occurs on the busbar 2, the terminal 3, and the like of the busbar module 1, waterdrops adhere to surfaces of the busbar 2, the terminal 3, and the like, and there is a concern that water accumulates in the case 4 that houses the busbar 2 and the terminal 3. In the battery module 10, the busbar module 1 is attached to a side surface of the battery cell 11 and disposed on a surface along the vertical direction Z, so that the structure allows water generated in the case 4 to flow downward.

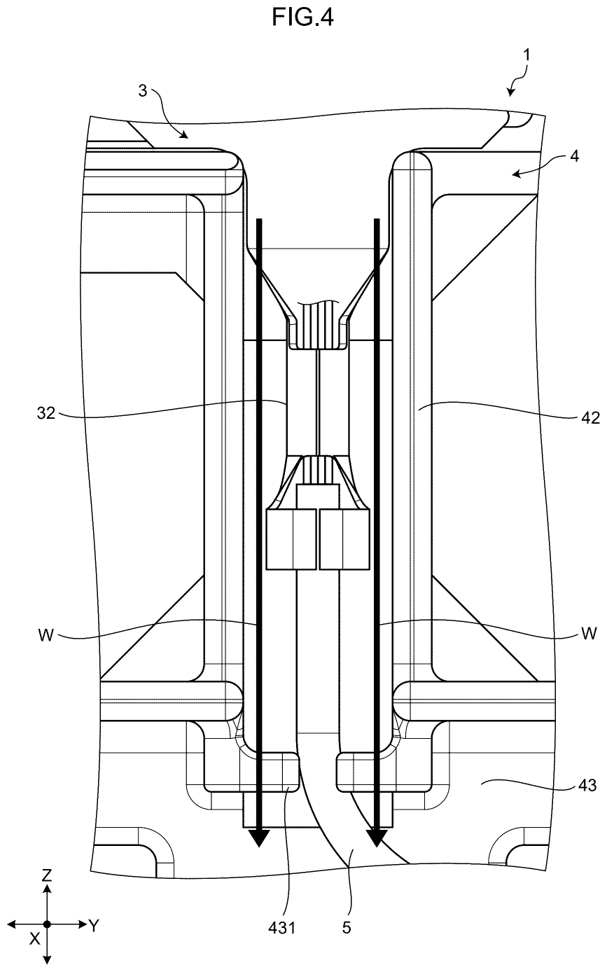

As illustrated in FIG. 4, when waterdrops adhere to the surfaces of the busbar 2 and the terminal 3, a plurality of the waterdrops become water W and flow from the busbar housing part 41 into the connection housing part 42. The water W enters the connection housing part 42, falls down, and is discharged to the electric wire housing part 43 below. At this point, a lower part of the connection housing part 42 does not have a floor part, and is open toward the lower side in the vertical direction Z. Due to this, the water W flows to the electric wire housing part 43 below without accumulating in the lower part of the connection housing part 42. Accordingly, it is possible to prevent the water W from staying in the connection housing part 42.

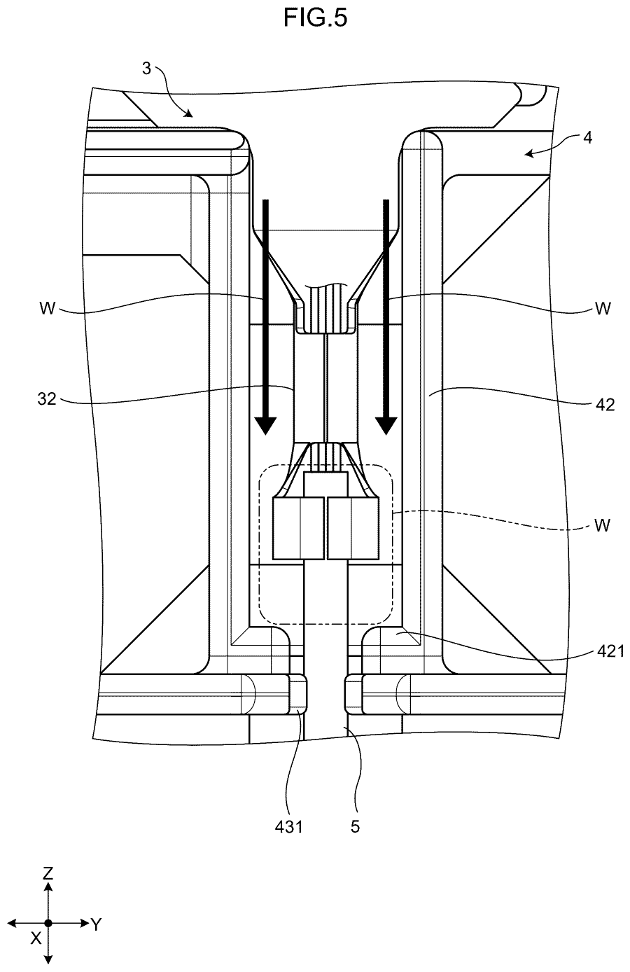

As illustrated in FIG. 5, for example, if a floor part 421 is formed in the connection housing part 42, the water W flowing down in the connection housing part 42 is less likely to flow out from the connection housing part 42 to the electric wire housing part 43 below, and may accumulate in the lower part of the connection housing part 42. On the other hand, as illustrated in FIG. 4, in the busbar module 1 according to the present embodiment, the water W flowing down in the connection housing part 42 smoothly flows out from the connection housing part 42 to the electric wire housing part 43 below. Due to this, the busbar module 1 according to the present embodiment can prevent the water W from staying in the lower part of the connection housing part 42, and can appropriately perform water processing.

As illustrated in FIG. 4, in the busbar module 1, the electric wire lock part 431 supporting the electric wire 5 is disposed in the electric wire housing part 43 below the connection housing part 42. Although a flow path of the water W is narrowed at a portion of the electric wire lock part 431, since the electric wire lock part 431 is disposed in the connection housing part 42 below the electric wire housing part 43, the water W smoothly flows out from the connection housing part 42. Due to this, the busbar module 1 according to the present embodiment can prevent the water W from staying in the lower part of the connection housing part 42, and can appropriately perform water processing.

In the busbar module 1, the connection part between the terminal 3 and the electric wire 5 is arranged at the center position of the connection housing part 42. Due to this, a distance can be ensured between the connection part between the terminal 3 and the electric wire 5, and the lower end of the connection housing part 42, and the electric wire lock part 431. Accordingly, even if the water W stays in the lower part of the connection housing part 42, it is possible to prevent the water W from entering the connection part between the terminal 3 and the electric wire 5. Furthermore, it is possible to prevent the water W that has flowed to the lower part of the connection housing part 42 from rising up to the connection part between the terminal 3 and the electric wire 5 due to surface tension. Particularly, it is possible to prevent the water W from rising up to a portion where the core wire is exposed at the end of the electric wire 5, and to prevent the water W from entering the inside of an insulating covering from the end of the electric wire 5.

As described above, the busbar module 1 according to the present embodiment includes the connection housing part 42 opened downward, so that it is possible to prevent water from staying in the connection housing part 42, and to appropriately perform water processing in the case 4.

By disposing the electric wire lock part 431 below the connection housing part 42, the busbar module 1 according to the present embodiment can prevent waterdrops adhering to the electric wire lock part 431 from moving to the connection part between the terminal 3 and the electric wire 5 housed in the connection housing part 42.

Furthermore, the busbar module 1 according to the present embodiment can prevent the water W staying in the connection housing part 42 from entering the connection part between the terminal 3 and the electric wire 5 by arranging the connection part between the terminal 3 and the electric wire 5 at the center position or a position above the center of the connection housing part 42.

The busbar module according to the present invention is not limited to the embodiment described above, and various modifications can be made within the scope of the claims. The busbar module 1 according to the present embodiment may be configured by appropriately combining the constituent elements in the embodiment described above.

For example, although the connection part between the terminal 3 and the electric wire 5 is arranged at the center position of the connection housing part 42 in the busbar module 1 according to the embodiment described above, the connection part between the terminal 3 and the electric wire 5 may be arranged at a position above the center of the connection housing part 42. Even in this case, similarly to the busbar module 1 described above, it is possible to prevent the water W staying in the connection housing part 42 from entering the connection part between the terminal 3 and the electric wire 5.

In the above description, the busbar module 1 according to the embodiment is used while being mounted on a vehicle, but may be used without being mounted on a vehicle.

With the busbar module according to the present invention, water processing can be appropriately performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar module comprising:
a busbar connected to a battery cell;
a terminal connected to the busbar; and
a case including a busbar housing part that houses the busbar and the terminal, and a connection housing part that is disposed to communicate with a lower side of the busbar housing part and houses a connection part between the terminal and the electric wire, wherein
the connection housing part is formed to be open downward in a vertical direction in a state of being assembled to the battery cell.

2. The busbar module according to claim 1, further comprising:
an electric wire lock part that supports the electric wire from a lateral side, and is disposed below the connection housing part.

3. The busbar module according to claim 1, wherein
the connection part is arranged at a center position or a position above the center of the connection housing part.

4. The busbar module according to claim 2, wherein
the connection part is arranged at a center position or a position above the center of the connection housing part.
